(19) United States
(12) Patent Application Publication
(10) Pub. No.: US 2004/0172298 A1
(43) Pub. Date: Sep. 2, 2004

(54) Automated clinical system to facilitate the process of providing notice of laboratory result publication

(76) Inventors: Lori N. Cross, Kansas City, MO (US); Michael R. Caldwell, Shawnee, KS (US); Thomas R. Cooke, Washington, DC (US); Keith Huffman, Lee's Summit, MO (US); G. Andrew Walker JR., Liberty, MO (US)

Correspondence Address: SHOOK, HARDY & BACON LLP, 2555 GRAND BLVD, KANSAS CITY,, MO, 64108, US

(21) Appl. No.: 10/730,668

(22) Filed: Dec. 8, 2003

Related U.S. Application Data
(60) Provisional application No. 60/431,361, filed on Dec. 6, 2002.
(60) Provisional application No. 60/437,833, filed on Jan. 3, 2003.

(51) Int. Cl. G06F 17/60

(52) U.S. Cl. 705/2

(57) ABSTRACT

The invention overcoming these and other problems in the art relates in one regard to a system and method in a computer system for facilitating the process of providing notice of laboratory result publication. An automated system solution is provided to facilitate the callback process. Laboratory results from a laboratory information system (LIS) database are posted to an electronic medical record (EMR) database either directly or through an interface. The system creates a callback request for each result that needs to be communicated back to the physician. The request may be based on the ordered procedure, the resulted assay, or the actual assay results (and associated assay result flags). In another embodiment of the system, a system and method for automatically managing the handling of callback processes is provided.

### CROSS-REFERENCE TO RELATED APPLICATIONS

This application claims the benefit of U.S. Provisional Patent Application Serial No. 60/431,361, filed Dec. 6, 2002 entitled “Automated Clinical System to Facilitate the Process of Providing Notice of Laboratory Result Publication” and U.S. Provisional Patent Application Serial No. 60/437,833, filed Jan. 3, 2003 entitled “Automated Clinical System to Facilitate the Process of Providing Notice of Laboratory Result Publication”.

### STATEMENT REGARDING FEDERALLY SPONSORED RESEARCH OR DEVELOPMENT

Not applicable.

### FIELD OF THE INVENTION

The present invention relates to a computer system and, more particularly, to an automated computer system to facilitate the process of providing notice of laboratory result publication.

### BACKGROUND OF THE INVENTION

Laboratories are the backbone supporting the provision of healthcare. As such, it is critical that laboratory results are communicated to the care provider in a time sensitive and efficient manner. In healthcare information technology systems, once the results are received by the system, a standard results publication process communicates the results to the relevant physician. The standard results publication process centers around a printed report that is reviewed by the doctor at the end of the work day or a similarly convenient time. In addition to the standard results publication process, many clinical and pathology laboratories maintain and support a process whereby physicians are notified of certain laboratory results in a manner outside of the printed report. In the industry, this process is sometimes termed “callback” since the process is typically completed by a laboratory employee placing a phone call to contact the doctor to provide notice of results. These laboratories might notify the doctor of certain results based on the “normalcy” of the results. For instance, the results may be deemed normal, abnormal, high or low. A callback may be required for any results that are not normal. In other circumstances, the criticality of the results may be used as the basis for determining if a call to the physician is required. In other cases, the parameters around the laboratory order rather than the results of the order may serve as the basis for a call to occur. For example, information relevant to the ordering physician, ordered procedure, or ordered priority may trigger notification. In another example, instead of initiating the call based on the order or result, information regarding the assay may be used to determine if a call should be made to the physician.

Laboratory information systems publish laboratory results to a database dedicated to storing laboratory information. As mentioned above, some laboratory information systems employ callback systems that notify a user of the system that a callback is required based on the callback criteria. Typically, when the call is complete, these callback systems receive input from the user documenting the completion of the call. However, many laboratory information systems do not have callback systems to notify the user of requests requiring callback. These processes rely on people to determine if a callback is required.

Also, in order for the callback process to be effective and trusted, a laboratory must define and consistently execute the callback commitment made to the physician community. If the laboratory agrees to make a phone call to the physician for every critical result value (or other value requiring callback based on the relevant criteria), then the laboratory must successfully contact the physician for every critical value reported. If the laboratory does not meet the laboratory's commitment to contact the physician community for certain types of results, then the laboratory's credibility and trustworthiness are compromised. Prior solutions are manual and do not automate the process of notifying the physician. As such, these systems suffer from the failures of human memory and execution, oftentimes at the cost of patient safety and efficiency.

### SUMMARY OF THE INVENTION

The invention overcoming these and other problems in the art relates in one regard to a system and method in a computer system for facilitating the computerized process of providing notice of laboratory result publication. An automated system solution is provided to facilitate the callback process. Laboratory results from a laboratory information system (LIS) database are posted to an electronic medical record (EMR) database either directly or through an interface. The system creates a callback request for each result that needs to be communicated back to the physician. The request may be based on the ordered procedure, the resulted assay, or the actual assay results (and associated assay result flags). In another embodiment of the system, a system and method for automatically managing the handling of callback processes is provided. Additional advantages and novel features of the invention will be set forth in part in a description which follows, and in part will become apparent to those skilled in the art upon examination of the following, or may be learned by practice of the invention.

### BRIEF DESCRIPTION OF THE DRAWINGS

FIG. 1 illustrates an overall architecture in which an automated clinical system may operate to facilitate the process of providing notice of laboratory result publication according to an embodiment of the invention.

FIG. 2 illustrates a flowchart of the overall method for facilitating the process of initiating a callback request utilizing an electronic medical record database.

FIG. 3 illustrates a flowchart of the overall method for automatically completing a callback request to provide notice of laboratory result publication.

### DETAILED DESCRIPTION OF EMBODIMENTS

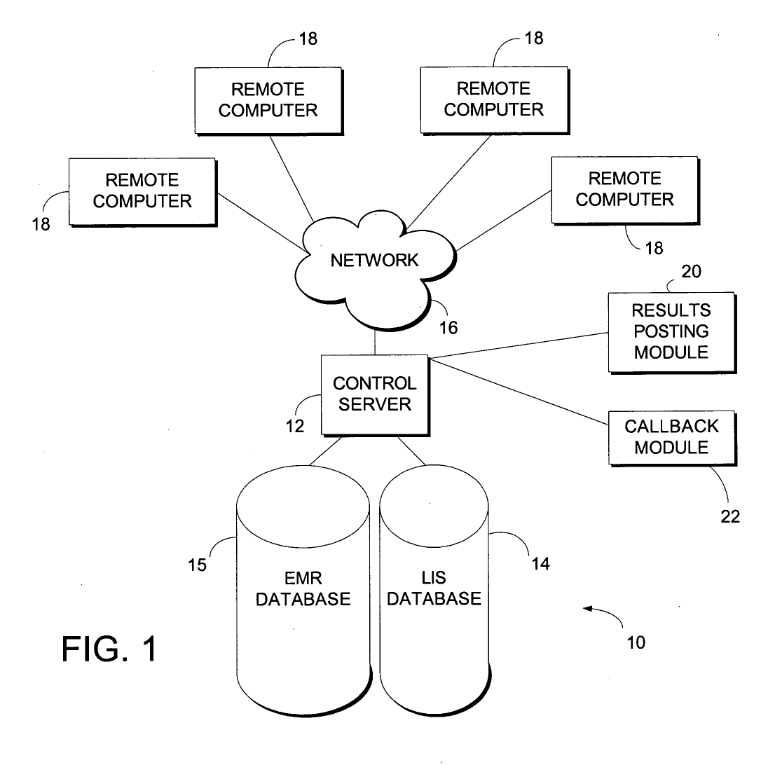

FIG. 1 illustrates an example of a computing system environment 10 in which a system and method for facilitating the process of providing notice of laboratory result publication, according to an embodiment of the invention.

The computing system environment 10 is only one example of a suitable computing environment and is not intended to suggest any limitation as to the scope of use or functionality of the invention. Neither should the computing environment 10 be interpreted as having any dependency or requirement relating to any one or combination of components illustrated in the exemplary environment 10.

The invention is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include, but are not limited to, routines, programs, objects, components, and data structures that perform particular tasks or implement particular abstract data types. The invention may also be practiced in distributed computing environments where tasks are performed by remote processing devices that are linked through a communications network. In a distributed computing environment, program modules may be located in both local and remote computer storage media, including memory storage devices.

With reference to FIG. 1, an exemplary system for implementing the invention includes a general purpose computing device in the form of server 12. Components of server 12 may include, but are not limited to, a processing unit, internal system memory, and a suitable system bus for coupling various system components, having a database cluster including an laboratory information system (LIS) database 14 and an electronic medical record (EMR) database 15 in communication with the control server 12. The system bus may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

Server 12 typically includes therein or has access to a variety of computer readable media, for instance, database cluster 14. Computer readable media can be any available media that can be accessed by server 12, and includes both volatile and nonvolatile media, removable and nonremovable media. By way of example, and not limitation, computer readable media may comprise computer storage media and communication media. Computer storage media may be implemented in any method or technology for storage of information, such as computer readable instructions, data structures, program modules or other data. Computer storage media includes, but is not limited to, RAM, ROM, EEPROM, flash memory or other memory technology, CD-ROM, digital versatile disks (DVD), or other optical disk storage, magnetic cassettes, magnetic tape, magnetic disk storage, or other magnetic storage devices, or any other medium which can be used to store the desired information and which can be accessed by server 12. Communication media typically embodies computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media such as acoustic, RF, infrared and other wireless media. Combinations of any of the above should also be included within the scope of computer readable media.

The computer storage media, including database cluster 14, discussed above and illustrated in FIG. 1, provide storage of computer readable instructions, data structures, program modules, and other data for server 12. Server 12 may operate in a computer network 16 using logical connections to one or more remote computers 18. Remote computers 18 can be located at a variety of locations in a medical or clinical laboratory environment, for example, but not limited to, hospitals, other inpatient settings, and testing labs. The remote computers may be physically located in a non-traditional clinical laboratory or medical care environments so that the entire health care community is capable of integration on the network. Each remote computer 18 may be a personal computer, server, router, a network PC, an interfaced instrument, a peer device or other common network node, and may include some or all of the elements described above relative to server 12. Computer network 16 may be a local area network (LAN) and/or a wide area network (WAN), but may also include other networks. Such networking environments are commonplace in offices, enterprise-wide computer networks, intranets and the Internet. When utilized in a WAN networking environment, server 12 may include a modem or other means for establishing communications over the WAN, such as the Internet. In a networked environment, program modules or portions thereof may be stored in server 12, or database cluster 14 and 15, or on any of the remote computers 18. For example, and not limitation, various application programs may reside on the memory associated with any one or all of remote computers 18. It will be appreciated that the network connections shown are exemplary and other means of establishing a communications link between the computers may be used.

By way of example, a user may enter commands and information into server 12 or convey commands and information to the server 12 via remote computers 18 through input devices, such as keyboards or pointing devices, commonly referred to as a mouse, trackball, or touch pad. Other input devices may include accepting data from an interface or logic system, microphone, satellite dish, scanner or the like. Server 12 and/or remote computers 18 may have any sort of display device, for instance, a monitor. In addition to a monitor, server 12 and/or computers 18 may also include other peripheral output devices, such as speakers and printers.

Although many other internal components of server 12 and computers 18 are not shown, those of ordinary skill in the art will appreciate that such components and their interconnection are well known. Accordingly, additional details concerning the internal construction of server 12 and computers 18 need not be disclosed in connection with the present invention.

Although the method and system are described as being implemented in a WINDOWS operating system operating in conjunction with a comprehensive healthcare network, one skilled in the art would recognize that the method and system can be implemented on any system supporting the receipt and processing of clinical laboratory results including an Internet-based architecture.

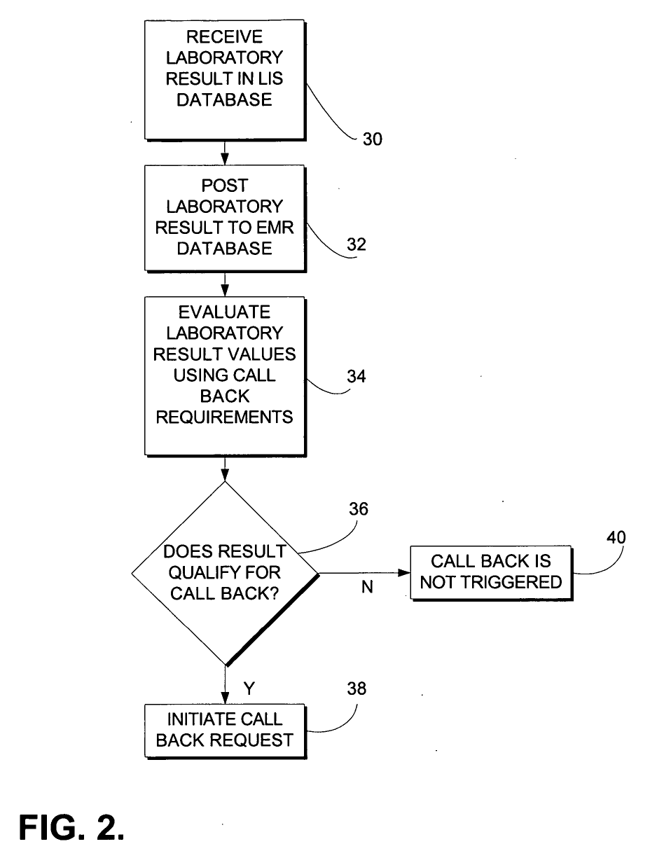

As illustrated in FIG. 2, a method in a computer system for facilitating the process of initiating a callback process is illustrated. The process begins at block 30 by publication (or verification) of a clinical laboratory result in the laboratory information system (LIS) database. The LIS database is dedicated to the laboratory information system. The LIS manages the workflow in the laboratory including the steps around the receipt of laboratory results. A clinical laboratory result includes, but is not limited to, numeric and codified values depicting the results from clinical laboratory tests such as chemistry, hematology, microbiology and blood bank departmental testing. Two well known laboratory information systems are the system offered by Cerner Corporation of Kansas City, Mo. under the trademark PATHNET and the system offered by Misys Healthcare Systems of Raleigh, N.C. under the trademark MISYS LABORATORY formerly SUNQUEST.

Once the results are published in the LIS database, at block 34 the laboratory results from the LIS database (14 in FIG. 1) are posted to the EMR database (15 in FIG. 1). As known in the art, an EMR database includes clinical event information and other information traditional found in a paper-based chart. Typically, clinical events occurring throughout the lifetime of the patient are stored in a number of clinical event tables in the EMR database. A clinical event includes, but is not limited to documentation of patient activities, patient history, discharge summaries, medication administration records, images and test results. With reference to FIG. 1, if the LIS database 14 and EMR database 15 use similar data formats, then the results posting module 20 writes the laboratory results directly to the EMR database. By way of example, the EMR database offered under the trademark OPEN CLINICAL FOUNDATION by Cerner Corporation uses a similar data format to the LIS offered by Cerner Corporation under the PATHNET trademark. If the LIS database and EMR database are foreign to one another and use dissimilar data formats, the information from LIS database 14 is published to the EMR database 15 by posting module 20 through an interface. As known in the art, one commonly used interface in the health care information technology area uses the Health Level Seven (HL7) standard protocol for electronic data exchange between computer systems.

Once the information is posted to the EMR database, callback initiation and documentation processes previously employed within laboratory information systems may be used by the EMR system. Specifically, with reference back to FIG. 2, at block 34 the callback module evaluates the laboratory results using callback criteria. The callback criteria may be based on the ordered procedure, resulted assay, reference range flag, critical range flag, ordering physician or ordering location. Other limitations are contemplated as mentioned in the background.

Next, at decision block 36, the system determines if the result qualifies for callback using the evaluation made at block 34. If the result qualifies for callback, at block 38 the callback module (22 in FIG. 1) initiates the callback process. In other words, the system notifies the user that a callback is required and generates a callback request. Once the call is completed, the callback module documents the completion of the call. If the result does not qualify for a callback, then a callback is not triggered at block 40.

The present invention allows staff outside the laboratory to manage the callback process by use of the EMR system and EMR database. Currently, there is a significant shortage of qualified laboratory personnel. By distributing the callback responsibilities to those outside of the laboratory setting, the laboratory personnel may direct their focus on other highly valued activities in the laboratory. Moreover, the system enables automated callback identification for laboratory results initially published to a LIS that does not support such functionality. This enables laboratory personnel having these types of laboratory systems to reap the benefits of automated callback. As such, the benefits and safety of an automated callback system may be enjoyed without the expense of replacing existing an existing LIS.

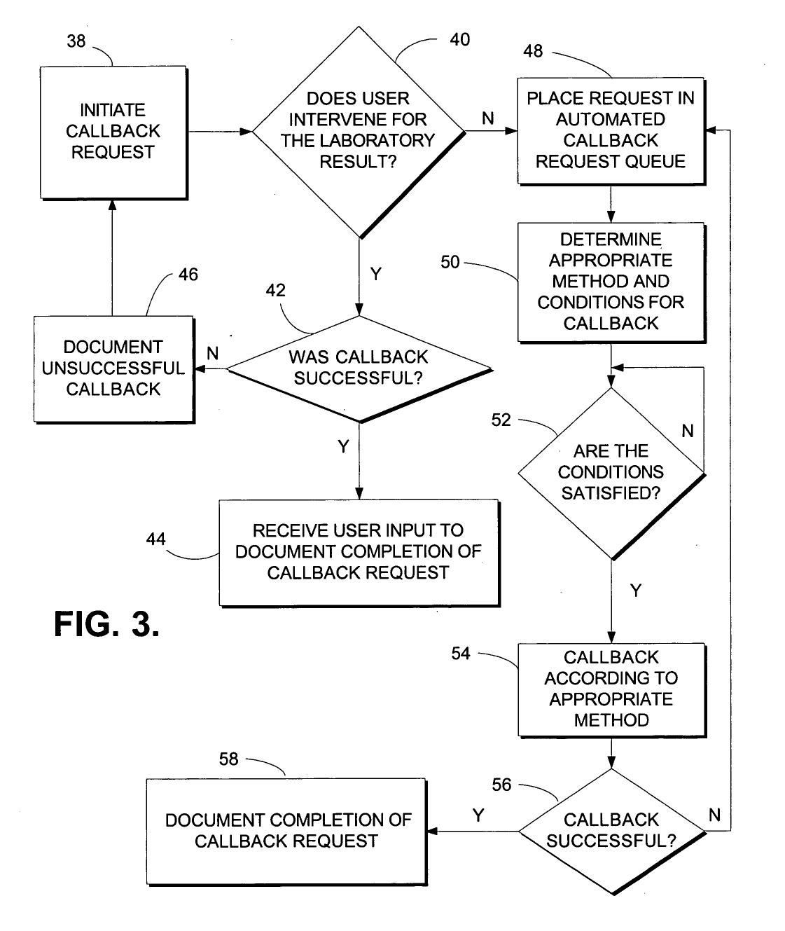

With reference to FIG. 3, automatically completing a callback request to provide notice of laboratory result publication is provided. More specifically, the system and method of the present invention manages the actually callback process rather than merely notifying the user of the information system that callback is required and documenting when the manual callback request is completed by a user.

After a callback request is initiated at step 38 from either an LIS database or EMR database (according to the method in FIG. 2), the system determines if a user will intervene and complete the call back request at decision block 40. In a preferred embodiment, one or more laboratory test results requiring callback are presented to the user by a graphical user interface. If the user intervenes at block 40 by selection of a callback request, the system presents the user with information required to complete the callback. In a preferred embodiment, patient information from the EMR database is provided to the user including name, telephone number and patient location. In another alternative, a rule or filter may identify certain callback requests so that the requests are only completed manually.

Next, at block 42, the system determines if the manual callback of the user was successful. Preferably, a graphical user interface prompts the user to provide input when the callback is complete. If the callback is successful, at block 42, the user provides input to the system documenting that the callback was completed. Preferably, the system records the time and date of the completion of the callback and removes the particular laboratory result from the queue presented to the user at block 42. This graphical user interface may be provided during or after the patient callback information is provided at block 42. If the callback is successful at decision block 42, the user provides input that the call was a success and provides other pertinent information at block 44 and the callback request is completed and stored.

If the user does not intervene at decision block 40, the callback request is placed in an automated callback request queue at block 48. Next, at regular time intervals, for each callback request, the system determines the appropriate method and conditions for callback at block 50. The methods of callback include but are not limited to phone, fax, paging, forwarding the message via email, or publishing to a system inbox. The method may be determined by information relating to the laboratory client, physician, the physician's schedule, the available device, time of day or any of a number of other criteria. For example, the system may access the physician's schedule to determine if the call should be made to the physician's home, the physician's office or any of a number of facilities that the physician attends. In another example, the callback may be communicated indirectly to the physician by calling or otherwise communicating the result to the physician's nurse. Also, a number of conditions may be applied before allowing a call or other communication to be made. For example, a physician may include a condition that no laboratory calls are made from 8:00 PM to 8:00 AM. Other conditions that would prevent the call from being made would be based on the physician's schedule. For example, if the physician is performing surgery, then no calls would be made.

Once the appropriate method is determined, the system determines at decision block 52 if the conditions for the particular method and laboratory result are satisfied. If the conditions are not satisfied, the system may wait until the conditions become satisfied. Alternatively, the callback request may be automatically placed back into the automated callback queue since the appropriate method for the fulfilling the callback request may change before the conditions are completed for the initially selected method. Alternatively, the system may hold the request for a particular period of time and wait for the conditions to be satisfied. If the conditions are not satisfied in the predefined time period, the requests may be routed to the results queue at block 48 or to the beginning of the process at block 38.

If the conditions are satisfied, the callback is made at block 54 in accordance with the appropriate method determined at block 50. The call or other communication may be placed by any of a number of automated technologies known to those of skill in the art. In a preferred embodiment, an automated voice response system is employed to complete the callback request if the preferred method is telephonic. In this preferred embodiment, an identification code or PIN is utilized to identify the party receiving the call to protect the potentially sensitive patient information. Next, the system determines if the callback is successful at decision block 56. If the callback is successful, the system documents the completion of the callback request at step 58. If the callback is not successful at decision block 56, then the callback request is sent to the callback queue at block 48. The fact that the initial callback was incomplete is stored at this point. In many cases, an incomplete call may change the appropriate method of callback determined at step 50. For example, if the initial attempt to call a physician is unsuccessful, then the callback request may be escalated to the physician's pager or mobile phone. Further, one or more of unsuccessful attempts by the automated system may trigger notification to a person besides the desired recipient of the call. In one example, the callback request may be routed to the user of the system and required for human intervention.

The foregoing description of the invention is illustrative, and modifications in configuration and implementation will occur to persons skilled in the art. For instance, while the invention has generally been described in terms of a single LIS database 14 which communicates with callback module 22 to callback processes, in embodiments more than one LIS database may communicate with a central callback module to automate the callback process. Other hardware, software or other resources described as singular may in embodiments be distributed, and similarly in embodiments resources described as distributed may be combined. The scope of the invention is accordingly intended to be limited only by the following claims.

We claim:

1. A computerized system for managing the communication a laboratory result to a person placing a laboratory order, comprising:
a laboratory information system data store storing clinical laboratory results for clinical laboratory orders;
an electronic medical record data store storing clinical event information;
a results posting module communicating with the laboratory information system data store and electronic medical record data store, the results posting module configured to publish clinical laboratory results from the laboratory information system data store to the electronic medical record data store; and
a callback module for selectively identifying a clinical laboratory result requiring a communication to the person placing the laboratory order for the selected clinical laboratory result.

2. A system according to claim 1, wherein the results posting module publishes the clinical laboratory results through a data exchange interface.

3. A system according to claim 1, wherein the callback module selectively identifies the clinical laboratory result requiring communication based on information about the clinical laboratory order.

4. A system according to claim 1, wherein the callback module selectively identifies the clinical laboratory result requiring communication based a comparison of the laboratory result and a clinically range relevant to the laboratory result.

5. A system according to claim 1, wherein the callback module selectively identifies the clinical laboratory result requiring communication based on information associated with the person placing the laboratory orders resulting in the clinical laboratory result.

6. A system according to claim 1, wherein the results posting module publishes the clinical laboratory results directly from the laboratory information system data store to the electronic medical records data store.

7. A method in a computer environment of managing the communication a laboratory result to a person placing a laboratory order, comprising:
accessing a laboratory information system data store containing a plurality of laboratory results;
posting the laboratory results from the laboratory information system data store to an electronic medical records data store; and
selectively identifying a clinical laboratory result requiring a communication to the person placing the laboratory order.

8. A method according to claim 7, wherein the laboratory results are posted through a data exchange interface.

9. A method according to claim 7, wherein the step of selectively identifying a clinical laboratory result comprises performing an analysis of the clinical laboratory order for the clinical laboratory results.

10. A method according to claim 7, wherein the step of selectively identifying a clinical laboratory result comprises comparing the laboratory result to a clinically range relevant to the laboratory result.

11. A method in a computing environment for communicating a laboratory result to a person placing a laboratory order, comprising:
accessing a data store containing a plurality of clinical laboratory results;
selectively identifying a clinical laboratory result requiring communication to the person placing the laboratory order for the selected clinical laboratory result;
identifying a first preferred notification method for the selected laboratory result; and
automatically generating a communication of the selected laboratory result by the first preferred method.

12. A method according to claim 11, further comprising the step of determining if the communication of the laboratory result is successfully completed, and, if not, identifying a second preferred method for the selected laboratory result and automatically generating a communication of the laboratory result by the second preferred method.

13. A method according to claim 11, wherein the first preferred method is identified based a schedule containing a location for the person placing the laboratory order.

14. A method according to claim 11, wherein the first preferred method is based on the availability of a communication device associated with the person placing the laboratory order.

15. A method according to claim 11, wherein the first preferred notification method is a telephone call to a particular phone number and wherein the first preferred notification method is identified from a plurality of notification methods associated with different phone numbers.

16. A method according to claim 11, wherein the laboratory result is communicated by the first preferred notification method through a delegate of the person placing the laboratory order.

17. A method according to claim 11, wherein the first preferred notification method is a telephone call to a particular phone number and wherein the first preferred notification method is identified from a plurality of notification methods associated with different phone numbers.

18. A method in a computing environment for communicating a laboratory result to a person placing a laboratory order, comprising:
accessing a data store containing a plurality of clinical laboratory results;
selectively identifying a clinical laboratory result requiring communication to the person placing the laboratory order for the selected clinical laboratory result;
identifying a first preferred notification method for the selected laboratory result from a plurality of notification methods;
identifying a number of conditions for the preferred method; and
if the conditions are satisfied, automatically generating a communication of the laboratory result by the first preferred method.

19. A method according to claim 18, further comprising the step of determining if the communication of the laboratory result is successfully completed, and, if not, identifying a second preferred method from the plurality of notification methods and automatically generating a communication of the laboratory result by the second preferred method.

20. A method according to claim 18, wherein the conditions relate to the schedule of the person placing the laboratory order.

21. A method according to claim 18, wherein the laboratory result is communicated by the first preferred notification method through a delegate to the person placing the laboratory order.
